(19) United States
(12) Patent Application Publication
(10) Pub. No.: US 2025/0210218 A1
(43) Pub. Date: Jun. 26, 2025

(54) INSULATED WIRE AND PRODUCTION METHOD THEREFOR

(71) Applicant: DAIKIN INDUSTRIES, LTD., Osaka (JP)

(72) Inventors: Seika FUJIOKA, Osaka (JP); Hiroaki WADA, Osaka (JP); Kazushi HORISAWA, Osaka (JP); Masamichi SUKEGAWA, Osaka (JP); Kenjiro TANIMOTO, Osaka (JP); Hideki KONO, Osaka (JP)

(73) Assignee: DAIKIN INDUSTRIES, LTD., Osaka (JP)

(21) Appl. No.: 19/062,438

(22) Filed: Feb. 25, 2025

Related U.S. Application Data
(63) Continuation of application No. PCT/JP2023/030691, filed on Aug. 25, 2023.

(30) Foreign Application Priority Data
Aug. 25, 2022 (JP) 2022-134381

(51) Int. Cl. H01B 3/44; H01B 7/00; H01B 13/00; H01B 13/14

(52) U.S. Cl. CPC H01B 3/445; H01B 7/0009; H01B 13/0016; H01B 13/14

(57) ABSTRACT

Provided is an insulated electric wire including a conductor and a fluororesin layer containing a melt-fabricable fluororesin that is formed on the conductor, in which a peel strength measured by peeling the fluororesin layer from the conductor is 0.30 N/mm or more.

### CROSS-REFERENCE TO RELATED APPLICATIONS

This application is a Rule 53(b) Continuation of International Application No. PCT/JP2023/030691 filed Aug. 25, 2023, which claims priority based on Japanese Patent Application No. 2022-134381 filed Aug. 25, 2022, the respective disclosures of which are incorporated herein by reference in their entirety.

### TECHNICAL FIELD

The present disclosure relates to an insulated electric wire and a production method thereof.

### BACKGROUND ART

Patent Document 1 describes an insulated electric wire having an insulating layer of fluororesin disposed on a conductor, wherein the insulating layer and the conductor are induction heated to achieve a peel strength of the insulating layer to the conductor of 0.05 N/mm or more.

Patent Document 2 describes an insulated electric wire including an oxide film on the surface of a conductor formed by electric heating.

Patent Document 3 describes an insulated electric wire mainly composed of polyether ketone ketone resin produced by heating a conductor under conditions without crystallization of polyether ketone ketone.

Patent Document 4 describes an insulated electric wire mainly composed of polyphenylene sulfide and polyether ketone ketone, produced by electric heating up to 360 degrees.

### RELATED ART

### Patent Document

Patent Document 1: Japanese Patent Laid-Open No. 2009-245857
Patent Document 2: Japanese Patent Laid-Open No. 2014-154511
Patent Document 3: Japanese Patent Laid-Open No. 2015-138626
Patent Document 4: Japanese Patent Laid-Open No. 2014-103045

### SUMMARY

According to the present disclosure, provided is an insulated electric wire including a conductor and a fluororesin layer containing a melt-fabricable fluororesin that is formed on the conductor, wherein a peel strength measured by peeling the fluororesin layer from the conductor is 0.30 N/mm or more.

### Effects

According to the present disclosure, an insulated electric wire including a conductor and a fluororesin layer coating the conductor, in close contact to each other with sufficient strength can be provided.

### DESCRIPTION OF EMBODIMENTS

A specific embodiment of the present disclosure is described in detail as follows, though the present disclosure is not limited to the following embodiment.

The electric wire of the present disclosure includes a conductor and a fluororesin layer containing a melt-fabricable fluororesin that is formed on the conductor.

Since a fluororesin has non-stickiness, a fluororesin layer directly disposed on the conductor of an insulated electric wire causes a problem that adherence strength between the conductor and the fluororesin layer is insufficient. Accordingly, curving or bending a conventional insulated electric wire causes problems that the fluororesin layer floats from the conductor and wrinkles occur on the fluororesin layer.

In a first insulated electric wire of the present disclosure, the peel strength measured by peeling a fluororesin layer from a conductor is 0.30 N/mm or more. Accordingly, in the first insulated electric wire of the present disclosure, the conductor and the fluororesin layer coating the conductor are in close contact to each other with sufficient strength, so that by curving or bending, the fluororesin layer hardly floats from the conductor and wrinkles hardly occur on the fluororesin layer.

The cross-sectional shape of the conductor which the first insulated electric wire of the present disclosure has is typically an approximately rectangular shape. The first insulated electric wire of the present disclosure may be a flat wire. In particular, in the case where the cross-sectional shape of the conductor is a rectangular shape, when the insulated electric wire is bent in an edgewise direction, the fluororesin layer coating the bent outer periphery expands larger than the fluororesin layer coating the bent inner periphery, so that the fluororesin layer tends to be peeled off from the conductor to float. Also, when the insulated electric wire is bent in an edgewise direction, the fluororesin layer coating the bent outer periphery shrinks larger than the fluororesin layer coating the bent outer periphery, so that wrinkles tend to occur on the fluororesin layer. The first insulated electric wire of the present disclosure has sufficient adherence strength between the conductor and the fluororesin layer coating the conductor, so that even when bent in an edgewise direction, the fluororesin layer hardly floats from the conductor and wrinkles hardly tend to occur on the fluororesin layer.

The peel strength exhibited by the first insulated electric wire of the present disclosure is preferably 0.50 N/mm or more, more preferably 1.00 N/mm or more, still more preferably 1.70 N/mm or more, and particularly preferably 3.00 N/mm or more. The upper limit of the peel strength is not limited, and may be, for example, 10.00 N/mm.

The peel strength is a maximum tensile stress measured when a fluororesin layer is peeled from a conductor in the long axis direction (longitudinal direction) for a distance of 30 mm at a rate of 100 mm/min.

A second insulated electric wire of the present disclosure has a pullout strength of 4 N or more measured by pulling a fluororesin out from a conductor. Accordingly, in the second insulated electric wire of the present disclosure, the conductor and the fluororesin layer coating the conductor are in close contact to each other with sufficient strength, so that by curving or bending, the fluororesin layer hardly floats from the conductor and wrinkles hardly occur on the fluororesin layer.

The typical cross-sectional shape of the conductor that the second insulated electric wire of the present disclosure has is an approximately circular shape. The second insulated electric wire of the present disclosure may be a round wire.

The first insulated electric wire of the present disclosure has a pullout strength of preferably 5 N or more, more preferably 6 N or more, still more preferably 12 N or more and further preferably 20 N or more. The upper limit of the pullout strength is not limited, and may be, for example, 50 N.

The pullout strength is a maximum tensile stress measured when a fluororesin layer is pulled out from a conductor in the long axis direction (longitudinal direction) for a distance of 30 mm at a rate of 50 mm/min.

An insulated electric wire of which the cross-sectional shape is an approximately rectangular shape usually includes a flat plane having an enough width for measurement of the peel strength. On the other hand, an insulated electric wire of which the cross-sectional shape is an approximately circular shape usually includes no flat plane having an enough width for measurement of the peel strength, and in this respect, the insulated electric wire of which the cross-sectional shape is an approximately rectangular shape and the insulated electric wire of which the cross-sectional shape is an approximately circular shape are different.

The constitution of the conductor and the coating layer is described in more detail as follows. In the present disclosure, the first insulated electric wire or the second insulated electric wire may be simply referred to as an “insulated electric wire” in some cases.

### (Conductor)

The conductor may be a single wire, an assembled wire, a stranded wire, and a single wire is preferred. The cross-sectional shape of the conductor may be any of an approximately rectangular shape and an approximately circular shape.

The conductor is not limited as long as it is composed of a conductive material, and may be composed of a material such as copper, copper alloy, aluminum, aluminum alloy, iron, silver and nickel. One composed of copper, copper alloy, aluminum or aluminum alloy is preferred. Alternatively, a conductor plated with silver or nickel may be used. As the copper, an oxygen-free copper, low-oxygen copper, or copper alloy may be used.

In the case where a conductor has an approximately rectangular cross-sectional shape, i.e., in the case where a conductor is a flat conductor, the width of the cross section of the conductor may be 1 to 75 mm, and the thickness of the cross section of the conductor may be 0.1 to 30 mm. The outer peripheral diameter of the conductor may be 6.5 mm or more and 200 mm or less. The ratio of the width to the thickness may be more than 1 and 30 or less.

In the case where the conductor has an approximately circular cross section, i.e., in the case where the conductor is a round conductor, the diameter of the conductor is preferably 0.1 to 10 mm, more preferably 0.3 to 3 mm.

The surface roughness Sz of the conductor is preferably 0.2 to 12 μm, more preferably 1 μm or more, still more preferably 5 μm or more, and more preferably 10 μm or less, for further stronger adhesion between the conductor and the fluororesin layer.

The surface roughness of the conductor may be adjusted through surface treatment of the conductor by etching, blasting or laser processing. Also, the surface of the conductor may be roughened by surface treatment. The smaller the distance between protruding portions across a concave portion, the better. For example, a distance of 5 μm or less is preferred. Also, as the roughness, for example, the area of a concave portion is 1 μm² or less when protrusion portions on an unprocessed surface are cut. The convex/concave shape may be a crater-type single convex/concave shape, or may be an ant nest-like branch shape.

### (Fluororesin Layer)

The fluororesin layer contains a melt-fabricable fluororesin. In the present disclosure, the term “melt-fabricable” means that a polymer can be melted and processed using a conventional processing device such as an extruder and an injection molding machine. Accordingly, the melt-fabricable fluororesin has a melt flow rate measured by the following measurement method of usually 0.01 to 500 g/10 minutes.

The melt flow rate of the fluororesin is preferably 10 to 100 g/10 minutes. The upper limit of the melt flow rate is more preferably 80 g/10 minutes or less, still more preferably 70 g/10 minutes or less. A melt flow rate of 100 g/10 minutes or less is preferred in terms of suppressing occurrence of cracks during bending of an electric wire coated with the resin. The lower limit of the melt flow rate is preferably 20 g/10 minutes or more, and more preferably 50 g/10 minutes or more. A melt flow rate of 10 g/10 minutes or more is preferred in terms of suppressing occurrence of melt fracture during coating with the resin. The melt flow rate of the fluororesin in the above-described range allows a fluororesin layer to be easily formed, and the resulting fluororesin layer has excellent mechanical strength and appearance.

In the present disclosure, the melt flow rate of the fluororesin is a value obtained as the mass of polymer flowing out from a nozzle having an inner diameter of 2.1 mm and a length of 8 mm per 10 minutes (g/10 minutes) at 372° C. under a load of 5 kg, using a melt indexer (manufactured by Yasuda Seiki Seisakusho, Ltd.) according to ASTM D1238.

The melting point of the fluororesin is preferably 200 to 322° C., more preferably 210° C. or more, still more preferably 220° C. or more, particularly preferably 240° C. or more, and more preferably 320° C. or less.

The melting point can be measured using a differential scanning calorimeter [DSC].

Examples of the melt-fabricable fluororesin include a tetrafluoroethylene (TFE)/fluoroalkyl vinyl ether (FAVE) copolymer, a tetrafluoroethylene (TFE)/hexafluoropropylene (HFP) copolymer, a TFE/ethylene copolymer [ETFE], a TFE/ethylene/HFP copolymer, an ethylene/chlorotrifluoroethylene (CTFE) copolymer [ECTFE], polychlorotrifluoroethylene [PCTFE], a CTFE/TFE copolymer, polyvinylidene fluoride [PVdF], a TFE/vinylidene fluoride (VdF) copolymer [VT], polyvinyl fluoride [PVF], a TFE/VdF/CTFE copolymer [VTC], and a TFE/HFP/VdF copolymer.

From the viewpoints of excellence in heat resistance, moldability and electrical characteristics, and further stronger adhesion between the conductor and the fluororesin layer, the fluororesin is preferably at least one selected from the group consisting of a TFE/FAVE copolymer and a TFE/HFP copolymer.

The TFE/FAVE copolymer is a copolymer containing a tetrafluoroethylene (TFE) unit and a fluoroalkyl vinyl ether (FAVE) unit.

Examples of the FAVE that constitutes an FAVE unit include at least one selected from the group consisting of a monomer represented by a general formula (1):

CF₂═CFO(CF₂CFY¹O)ₚ—(CF₂CF₂CF₂O)_{q}—Rf (1)
wherein Y¹ represents F or CF₃, Rf represents a perfluoroalkyl group having 1 to 5 carbon atoms, p represents an integer of 0 to 5, and q represents an integer of 0 to 5; and
a monomer represented by a general formula (2):

CFX═CXOCF₂OR¹ (2)
wherein X are the same or different and represent H, F or CF₂; and R¹ represents a linear or branched fluoroalkyl group having 1 to 6 carbon atoms, which may contain 1 to 2 of at least one type of atoms selected from the group consisting of H, Cl, Br and I; or a cyclic fluoroalkyl group having 5 or 6 carbon atoms, which may contain 1 to 2 of at least one type of atoms selected from the group consisting of H, Cl, Br and I.

In particular, FAVE is preferably a monomer represented by the general formula (1), more preferably one selected from the group consisting of perfluoro(methyl vinyl ether), perfluoro(ethyl vinyl ether) (PEVE), and perfluoro(propyl vinyl ether) (PPVE), still more preferably one selected from the group consisting of PEVE and PPVE, and particularly preferably PPVE.

For further stronger adhesion between the conductor and the fluororesin layer, the FAVE unit content in the TFE/FAVE copolymer relative to all the monomer units is preferably 1.0 to 30.0 mol %, more preferably 1.2 mol % or more, still more preferably 1.4 mol % or more, further preferably 1.6 mol % or more, particularly preferably 1.8 mol % or more, and more preferably 3.5 mol % or less, still more preferably 3.2 mol % or less, further preferably 2.9 mol % or less, particularly preferably 2.6 mol % or less.

For further stronger adhesion between the conductor and the fluororesin layer, the TFE unit content in the TFE/FAVE copolymer relative to all the monomer units is preferably 99.0 to 70.0 mol %, more preferably 96.5 mol % or more, still more preferably 96.8 mol % or more, further preferably 97.1 mol % or more, particularly preferably 97.4 mol % or more, and more preferably 98.8 mol % or less, still more preferably 98.6 mol % or less, further preferably 98.4 mol % or less, particularly preferably 98.2 mol % or less.

In the present disclosure, the content of each monomer unit in the copolymer is measured by ¹⁹F-NMR method.

The TFE/FAVE copolymer may contain a monomer unit derived from a monomer copolymerizable with TFE and FAVE. In that case, the content of the monomer copolymerizable with TFE and FAVE relative to all the monomer units of the TFE/FAVE copolymer is preferably 0 to 29.0 mol %, more preferably 0.1 to 5.0 mol %, still more preferably 0.1 to 1.0 mol %.

Examples of the monomer copolymerizable with TFE and FAVE include HFP, a vinyl monomer represented by CZ¹Z²═CZ³(CF₂)ₙZ⁴, wherein Z¹, Z² and Z³ are the same or different and represent H or F; Z⁴ represents H, F or Cl; and n represents an integer of 2 to 10; an alkyl perfluoro vinyl ether derivative represented by CF₂═CF—OCH₂—Rf¹, wherein Rf¹ represents a perfluoroalkyl group having 1 to 5 carbon atoms; and a monomer having a functional group. In particular, HFP is preferred.

The TFE/FAVE copolymer is preferably one selected from the group consisting of a copolymer including a TFE unit and an FAVE unit only, and the TFE/HFP/FAVE copolymer; and more preferably the copolymer including a TFE unit and an FAVE unit only.

From the viewpoints of heat resistance and stress crack resistance, the melting point of the TFE/FAVE copolymer is preferably 240 to 322° C., more preferably 285° C. or more, and more preferably 320° C. or less, still more preferably 315° C. or less, particularly preferably 310° C. or less. The melting point may be measured by using a differential scanning calorimeter [DSC].

The glass transition temperature (Tg) of the TFE/FAVE copolymer is preferably 70 to 110° C., more preferably 80° C. or more, and more preferably 100° C. or less. The glass transition temperature may be measured by dynamic viscoelasticity measurement.

From the viewpoint of electrical characteristics, the relative dielectric constant of the TFE/FAVE copolymer is preferably 2.4 or less, more preferably 2.1 or less, and the lower limit is preferably 1.8 or more, though not limited. The relative dielectric constant is a value obtained by measuring the changes in the resonant frequency and the electric field intensity at a temperature of 20 to 25° C. using a network analyzer HP8510C (manufactured by Hewlett Packard Enterprise) and a cavity resonator.

The TFE/HFP copolymer is a copolymer containing tetrafluoroethylene (TFE) unit and hexafluoropropylene (HFP) unit.

For further stronger adhesion between the conductor and the fluororesin layer, the HFP unit content in the TFE/HFP copolymer relative to all the monomer units is preferably 0.1 to 30.0 mol %, more preferably 0.7 mol % or more, still more preferably 1.4 mol % or more, and more preferably 10.0 mol % or less.

For further stronger adhesion between the conductor and the fluororesin layer, the TFE unit content in the TFE/HFP copolymer relative to all the monomer units is preferably 70.0 to 99.9 mol %, and more preferably 90.0 mol % or more, more preferably 99.3 mol % or less, still more preferably 98.6 mol %.

The TFE/HFP copolymer may contain a monomer unit derived from a monomer copolymerizable with TFE and HFP. In that case, the content of the monomer copolymerizable with TFE and HFP relative to all the monomer units of the TFE/HFP copolymer is preferably 0 to 29.9 mol %, more preferably 0.1 to 5.0 mol %, still more preferably 0.1 to 1.0 mol %.

Examples of the monomer copolymerizable with TFE and HFP include FAVE, a vinyl monomer represented by CZ¹Z²=CZ³(CF₂)ₙZ⁴, wherein Z¹, Z² and Z³ are the same or different and represent H or F; Z⁴ represents H, F or Cl; and n represents an integer of 2 to 10; an alkyl perfluoro vinyl ether derivative represented by CF₂═CF—OCH₂—Rf¹, wherein Rf¹ represents a perfluoroalkyl group having 1 to 5 carbon atoms; and a monomer having a functional group. In particular, FAVE is preferred.

The melting point of the TFE/HFP copolymer is preferably 200 to 322° C., more preferably 210° C. or more, still more preferably 220° C. or more, particularly preferably 240° C. or more, and more preferably 320° C. or less, still more preferably less than 300° C., and particularly preferably 280° C. or less.

The glass transition temperature (Tg) of the TFE/HFP copolymer is preferably 60 to 110° C., more preferably 65° C. or more, and more preferably 100° C. or less.

It is preferable that the fluororesin have a functional group. Due to the fluororesin having a functional group, the conductor and the fluororesin can be in further firm contact.

The functional group is preferably at least one selected from the group consisting of a carbonyl group-containing group, an amino group, a hydroxy group, a —CF₂H group, an olefinic group, an epoxy group and an isocyanate group.

The carbonyl group-containing group is a group that contains a carbonyl group (—C(═O)—) in the structure. Examples of the carbonyl group-containing group include:
a carbonate group [—O—C(═O)—OR³, wherein R³ is an alkyl group having 1 to 20 carbon atoms or an alkyl group having 2 to 20 carbon atoms that contains an etheric oxygen atom],
an acyl group [—C(═O)—R³, wherein R³ is an alkyl group having 1 to 20 carbon atoms or an alkyl group having 2 to 20 carbon atoms that contains an etheric oxygen atom],
a haloformyl group [—C(═O)X⁵, wherein X⁵ is a halogen atom],
a formyl group [—C(═O)H],
a group represented by a formula: —R⁴—C(═O)—R⁵, wherein R⁴ is a divalent organic group having 1 to 20 carbon atoms, and R⁵ is a monovalent organic group having 1 to 20 carbon atoms,
a group represented by a formula: —O—C(═O)—R⁶, wherein R⁶ is an alkyl group having 1 to 20 carbon atoms, or an alkyl group having 2 to 20 carbon atoms that contains an etheric oxygen atom,
a carboxyl group [—C(═O)OH],
an alkoxycarbonyl group [—C(═O)OR⁷, wherein R⁷ is a monovalent organic group having 1 to 20 carbon atoms],
a carbamoyl group [—C(═O)NR⁸R⁹, wherein R⁸ and R⁹ may be the same or different, being a hydrogen atom or a monovalent organic group having 1 to 20 carbon atoms], and
an acid anhydride bond [—C(═O)—O—C(═O)—]. Specific examples of R³ include a methyl group, an ethyl group, a propyl group, an isopropyl group and a butyl group. Specific examples of R⁴ described above include a methylene group, a —CF₂— group and a —C₆H₄— group, and specific examples of R⁵ include a methyl group, an ethyl group, a propyl group, an isopropyl group and a butyl group. Specific examples of R⁷ include a methyl group, an ethyl group, a propyl group, an isopropyl group and a butyl group. Further, specific examples of R⁸ and R⁹ include a hydrogen atom, a methyl group, an ethyl group, a propyl group, an isopropyl group, a butyl group and a phenyl group.

The hydroxy group is a group represented by —OH or a group containing a group represented by —OH. In the present disclosure, —OH that constitutes a carboxyl group is not included in the hydroxy group. Examples of the hydroxy group include —OH, a methylol group and an ethylol group.

The olefinic group is a group having a carbon-carbon double bond. Examples of the olefinic group include a functional group represented by the following formula:

—CR¹⁰═CR¹¹R¹²
wherein R¹⁰, R¹¹ and R¹² may be the same or different, being a hydrogen atom, a fluorine atom or a monovalent organic group having 1 to 20 carbon atoms,
and at least one selected from the group consisting of —CF═CF₂, —CH═CF₂, —CF═CHF, —CF═CH₂ and —CH═CH₂ is preferred.

The isocyanate group is a group represented by —N═C═O.

Alternatively, examples of the functional group may include a non-fluorinated alkyl group or a partly fluorinated alkyl group such as a —CH₃ group and a —CFH₂ group.

For further stronger adhesion between the conductor and the fluororesin layer, the number of functional groups of the fluororesin is preferably 5 to 2,000 per 1,000,000 carbon atoms. The number of functional groups per 10⁶ carbon atom is more preferably 50 or more, still more preferably 100 or more, particularly preferably 200 or more, and more preferably 1,500 or less, still more preferably 1,300 or less, particularly preferably 1,100 or less, most preferably 1,000 or less.

Also, from the viewpoint of formability of the coating layer excellent in electrical characteristics, the number of functional groups of the fluororesin may be less than 5 piece per 10⁶ carbon atoms.

The functional group includes a functional group present at an end of the main chain or at an end of the side chain of a copolymer (fluororesin), and a functional group present in the main chain or in the side chain, suitably present at an end of the main chain. Examples of the functional group include —CF═CF₂, —CF₂H, —COF, —COOH, —COOCH₃, —CONH₂, —OH, —CH₂OH, and at least one selected from the group consisting of —CF₂H, —COF, —COOH, —COOCH₃ and —CH₂OH is preferred. The —COOH includes a dicarboxylic acid anhydride (—CO—O—CO—) which is formed through bonding of two —COOH.

In identification of the type of the functional group and measurement of the number of functional groups, infrared spectroscopy may be used.

Specifically, the number of functional groups are measured by the following method. First, a copolymer is melted at 330 to 340° C. for 30 minutes, and compression molded into a film having a thickness of 0.20 to 0.25 mm. The film is analyzed by Fourier transform infrared spectroscopy to obtain an infrared absorption spectrum of the copolymer. A differential spectrum, which is a difference from a base spectrum of completely fluorinated polymer having no functional group, is then obtained. From the absorption peak of a specific functional group in the differential spectrum, the number N of functional group per 1×10⁶ carbon atoms in the copolymer is calculated according to the following formula (A).

$$N = I \times K / t \qquad ( A )$$

I: absorbance
K: correction coefficient
T: film thickness (mm)

For reference sake, the absorption frequency, molar absorption coefficient and correction coefficient of the functional groups of the present disclosure are shown in Table 1. Incidentally, the molar absorption coefficient is determined from the FT-IR measurement data of a low molecular weight model compound.

TABLE 1

| | | Molar | | |
|---|---|---|---|---|
| | Absorption | Extinction | | |
| | Frequency | Coefficient | Correction | |
| Functional Group | (cm⁻¹) | (l/cm/mol) | Factor | Model Compound |
| —COF | 1883 | 600 | 388 | C₇F₁₅COF |
| —COOH free | 1815 | 530 | 439 | H(CF₂)₆COOH |
| —COOH bonded | 1779 | 530 | 439 | H(CF₂)₆COOH |
| —COOCH₃ | 1795 | 680 | 342 | C₇F₁₅COOCH₃ |
| —CONH₂ | 3436 | 506 | 460 | C₇H₁₅CONH₂ |
| —CH₂OH₂, —OH | 3648 | 104 | 2236 | C₇H₁₅CH₂OH |
| —CF₂H | 3020 | 8.8 | 26485 | H(CF₂CF₂)₃CH₂OH |
| —CF═CF₂ | 1795 | 635 | 366 | CF₂═CF₂ |

Incidentally, the absorption frequency of each of —CH₂CF₂H, —CH₂COF, —CH₂COOH, —CH₂COOCH₃ and —CH₂CONH₂ is lower by several tens of kayser (cm⁻¹) than the absorption frequency shown in Table for each of —CF₂H, —COF, free —COOH and bonded —COOH, —COOCH₃ and —CONH₂.

Accordingly, for example, the number of functional groups —COF is a total of the number of functional groups determined from the absorption peak at an absorption frequency of 1883 cm⁻¹ caused by —CF₂COF and the number of functional groups determined from the absorption peak at an absorption frequency of 1840 cm⁻¹ caused by —CH₂COF.

The number of functional groups may be a total number of —CF═CF₂, —CF₂H, —COF, —COOH, —COOCH₃, —CONH₂ and —CH₂OH, or may be a total number of —CF₂H, —COF, —COOH, —COOCH₃ and —CH₂OH.

The functional group is introduced into a fluororesin (copolymer), for example, from a chain transfer agent or a polymerization initiator used in production of the fluororesin. For example, in the case of using an alcohol as chain transfer agent, or using a peroxide having a —CH₂OH structure as polymerization initiator, —CH₂OH is introduced into an end of the main chain of the fluororesin. Also, in the case of polymerizing a monomer having a functional group, the functional group is introduced into an end of the side chain of the fluororesin. The fluororesin may contain a unit derived from a monomer having a functional group.

Examples of the monomer having a functional group include a cyclic hydrocarbon monomer having a dicarboxylic acid anhydride group (—CO—O—CO—) and having a polymerizable unsaturated group in a ring described in Japanese Patent Laid-Open No. 2006-152234, and a monomer having a functional group (f) described in International Publication No. WO 2017/122743. In particular, examples of the monomer having a functional group include a monomer having a carboxy group (maleic acid, itaconic acid, citraconic acid, undecylenic acid, etc.); a monomer having an acid anhydride group (itaconic acid anhydride, citraconic acid anhydride, 5-nobornene-2,3-dicarboxylic acid anhydride, maleic acid anhydride, etc.); and a monomer having a hydroxy group or an epoxy group (hydroxybutyl vinyl ether, glycidyl vinyl ether, etc.).

The fluororesin may be produced, for example, by a conventionally known method such as appropriately mixing a monomer as constituent unit and an additive such as polymerization initiator to perform emulsion polymerization or suspension polymerization.

The fluororesin layer may contain other components on an as needed basis. Examples of the other components include additives such as a cross-linking agent, an antistatic agent, a thermal stabilizer, a foaming agent, a foam nucleating agent, an antioxidant, a surfactant, a photopolymerization initiator, an anti-friction agent, a surface modifier, various organic/inorganic-based pigments, a copper inhibitor, an antifoaming agent, a tackifier, a lubricant, a processing aid, a colorant, a phosphorus-based stabilizer, a lubricant, a mold release agent, a sliding agent, a UV absorption agent, a dye/pigment, a reinforcement material, an anti-drip agent, a filler, a curing agent, a UV curing agent, and a flame retardant. The content of the other components in the fluororesin layer relative to the mass of the fluororesin in the fluororesin layer is preferably less than 30 mass %, more preferably less than 10 mass %, and still more preferably 5 mass % or less. The lower limit is not limited, and may be 0 mass % or more. In other words, the fluororesin layer may contain no other components.

In order to improve the mechanical properties, and forming processability, the fluororesin layer may include an additive and a filler. Examples thereof include fibrous filler such as glass fiber, carbon fiber, carbon milled fiber, carbon nanotube, carbon nanohorn, metal fiber, asbestos, rock wool, ceramic fiber, slug fiber, potassium titanate whisker, boron whisker, aluminum borate whisker, calcium carbonate whisker, titanium oxide whisker, wollastonite, palygorskite, seviolite, aramid fiber, alumina fiber, silicon carbide fiber, ceramic fiber, asbestos fiber, gypsum fiber, metal fiber, polyimide fiber and polybenzothiazole fiber, a silicate such as fullerene, talc, wallastonite, zeolite, mica, clay, pyrophyllite, graphite, silica, bentonite, asbestos and alumina silicate, a metal compound such as silicon oxide, magnesium oxide, calcium oxide, alumina, zirconium oxide, titanium oxide and iron oxide, a carbonate such as calcium carbonate, magnesium carbonate and dolomite, a sulfate such as calcium sulfate and barium sulfate, a hydroxide such as calcium hydroxide and aluminum hydroxide, glass beads, glass flakes, glass powder, boron nitride, silicon carbide, carbon black and graphite.

The fluororesin layer may have bubbles to effectively improve low dielectric properties. Examples of inorganic-based bubble nucleating agent include boron nitride, talc, zeolite, mica, aluminum silicate, calcium silicate, calcium carbonate, dolomite, magnesium oxide, magnesium hydroxide, aluminum oxide, aluminum hydroxide, antimony trioxide, titanium oxide and iron oxide. During processing of an electric wire, an inert gas, nitrogen, carbon dioxide, argon, helium or the like may be injected into the coating material to cause bubbling, so that bubbles can be obtained. A fine and hollow particle, a hollow capsule, a hollow balloon or a hollow polymer particle may be mixed into a material to obtain a bubble. Examples thereof include an acrylic hollow particle, a silica hollow particle, an alumina hollow particle, a ceramic hollow particle, a glass balloon and a glass hollow particle. The size of the hollow particle is preferably 10 μm or less, more preferably less than 1 μm, and still more preferably 500 nm or less. The lower limit is not limited, and may be 30 nm or more.

From the viewpoint of insulation properties, the thickness of the fluororesin layer is preferably 40 to 300 μm, more preferably 50 μm or more, still more preferably 60 μm or more, and more preferably 250 μm or less, still more preferably 200 μm or less.

The relative dielectric constant of the fluororesin layer is preferably 2.5 or less, more preferably 2.4 or less, still more preferably 2.3 or less, further preferably 2.2 or less, particularly preferably 2.1 or less, and preferably 1.8 or more. The relative dielectric constant is a value obtained by measuring the changes in the resonant frequency and the electric field intensity at a temperature of 20 to 25° C. using a network analyzer HP8510C (manufactured by Hewlett Packard Enterprise) and a cavity resonator.

From the viewpoint of insulating properties, it is preferable that the partial discharge inception voltage of an insulated electric wire measured at 25° C. satisfy the following relational expression.

Partial discharge inception voltage (V)≥5.5×t+600
t: film thickness of fluororesin layer (μm)

It is preferable that the partial discharge inception voltage of an insulated electric wire hardly change even when the temperature changes. The rate of change, which is calculated from the partial discharge inception voltage of an insulated electric wire measured at 25° C. and the partial discharge inception voltage measured at 200° C. based on the following formula, is preferably less than 10%, more preferably less than 5%.

$$Rate of change ( \% ) = [ ( Partial discharge inception voltage measured at 25 ° C . ) - \text{} ( Partial discharge inception voltage measured at 200 ° C . ) ] / \text{} ( Partial \text{} discharge inception voltage measured at 25 ° C . ) \times 100$$

### (Other Layers)

The insulated electric wire of the present disclosure may further include other layers formed on the outer periphery of the fluororesin layer.

In the insulated electric wire of the present disclosure, the conductor and the fluororesin layer are in close contact with each other with a sufficient strength, so that other layers are absent between the conductor and the fluororesin layer. In other words, the conductor and the fluororesin layer are directly in close contact.

Examples of the other layers include a layer formed on the outer periphery of the fluororesin layer, which contains a thermoplastic resin. Examples of the thermoplastic resin include a fluororesin, a thermoplastic polyimide resin, a thermoplastic polyamide imide resin, a polyamide resin, a polyolefin resin, a modified polyolefin resin, a polyvinyl resin, polyester, an ethylene/vinyl alcohol copolymer, a polyacetal resin, a polyurethane resin, a polyphenylene oxide resin, a polycarbonate resin, an acrylic-based resin, a styrene-based resin, an acrylonitrile/butadiene/styrene resin (ABS), a vinyl chloride-based resin, a cellulose-based resin, a polysulfone resin, a polyether sulfone resin (PES), a polyether imide resin, a polyphenylene sulfide resin, and a polyethylene terephthalate.

### (Method for Producing Insulated Electric Wire)

The insulated electric wire of the present disclosure may be produced, for example, with use of an extruder, by melting a fluororesin by heating, and extruding the fluororesin in a melted state onto a conductor to form a coating layer.

On this occasion, by extruding the fluororesin in a melted state onto a conductor heated to a temperature higher than the temperature of the fluororesin in a melted state, an insulated electric wire including the conductor in close contact with the fluororesin layer with a sufficient strength can be obtained.

The extruder is not limited, and an extruder having a cylinder, a die and a nipple with an opening through which the conductor is discharged may be used.

The temperature of the fluororesin in a melted state is usually equal to or more than the melting point of the fluororesin, preferably a temperature equal to or more than the melting point plus 15° C. of the fluororesin, more preferably a temperature equal to or more than the melting point plus 20° C. of the fluororesin, still more preferably a temperature equal to or more than the melting point of the fluororesin by 25° C. or more, further preferably a temperature equal to or more than the melting point plus 40° C. of the fluororesin, particularly preferably a temperature equal to or more than the melting point plus 80° C. of the fluororesin, and most preferably a temperature equal to or more than the melting point plus 100° C. of the fluororesin. The upper limit of the temperature of the fluororesin in a melted state is not limited, and from the viewpoint of suppressing pyrolysis of the resin during forming of the electric wire and suppressing discoloration of the resin during forming of the electric wire, a temperature of 510° C. or less is preferred, and a temperature of 450° C. or less is more preferred. The temperature of the fluororesin in a melted state may be adjusted by adjusting the cylinder temperature and the die temperature of the extruder. The temperature of the fluororesin in a melted state may be determined by measuring the temperature of the fluororesin discharged from the outlet of the die head using a thermocouple.

The temperature of the heated conductor is higher than the temperature of the fluororesin in a melted state, preferably a temperature equal to or more than the temperature of the fluororesin in a melted state plus 15° C., more preferably plus 20° C., still more preferably plus 30° C. The upper limit of the temperature of the heated conductor is not limited, and is, for example, 700° C. or less.

The temperature of the heated conductor may be determined by measuring the temperature of the conductor between the heating device and the extruder with a contact thermometer or a non-contact thermometer.

The temperature of the heated conductor may be adjusted by heating the conductor with a heating device before being fed into the extruder. Examples of the heating device include a halogen heater, a carbon heater, a tungsten heater, a hot-air heating device, an induction heating device, a micro-wave heating device, a superheated steam generator, and a burner, of which size, shape, number of the devices, number of the heating source, etc. are not limited as long as the device can heat a specific region to a high temperature all at once. Alternatively, a plurality of techniques may be used in a combination, and a plurality of heating sources may be used. Since a wide region can be uniformly irradiated all at once, heating with a halogen heater is preferred.

Conditions for heating are not limited as long as the temperature of the conductor becomes higher than the forming temperature (head temperature) when the conductor comes in contact with the resin, and the distance between the forming machine and the heating device may be close or far. Further, in order to keep the heat in the conductor, a different heating device, a heating tube, heat insulation pipe or an insulating material may be present around the traveling line after passing through the heating region of the conductor.

The line speed during extrusion may be 0.1 to 50 m/minute, preferably 20 m/minute or less.

After forming of the fluororesin layer, the electric wire may be cooled. The cooling method is not limited, and may include a method such as water cooling and air cooling. Through air cooling of the insulated electric wire, cooling can be performed at a moderate rate, so that the thickness of the fluororesin layer tends to be uniform.

After forming of the fluororesin layer, the insulated electric wire may be heat treated. The heat treatment may be performed before cooling or after cooling, provided that the fluororesin layer has been formed. The temperature for the heat treatment is usually equal to or more than the glass transition point of the fluororesin, preferably a temperature equal to or more than the melting point plus 15° C., and preferably a temperature equal to or less than the melting point plus 50° C. of the fluororesin.

After formation of the fluororesin layer, a material for forming another layer may be extruded to form the other layer on the fluororesin layer, or by simultaneous multilayer melt extrusion, another layer may be formed on the fluororesin layer together with forming of the fluororesin layer.

The insulated electric wire of the present disclosure is suitably used for, for example, an LAN cable, a USB cable, a lightning cable, an HDMI (registered trademark) cable, a QSFP cable, an electric wire for aerospace, an underground power cable, a submarine power cable, a high voltage cable, a superconducting cable, a wrapping electric cable, an electric wire for automobiles, a wire harness/electrical component, an electric wire for robots/FA, an electric wire for QA devices, an electric wire for information equipment (optical fiber cable, LAN cable, HDMI cable, lightening cable, audio cable, etc.), internal wiring for communication base stations, heavy-current internal wiring (inverter, power conditioners, battery storage systems, etc.), internal wiring for electronic devices, small electronic device/mobile wiring, moving part wiring, internal wiring of electric equipment, internal wiring of measuring devices, an electric power cable (for construction, wind power/solar power generation, etc.), a cable for control/instrument wiring, and a cable for motors.

The insulated electric wire of the present disclosure may be wound for use as a coil. The insulated electric wire and coil of the present disclosure may be suitably used for electric devices or electronic devices such as a motor, a generator, an inductor. Further, the insulated electric wire and coil of the present disclosure may be suitably used for on-vehicle electric devices or on-vehicle electronic devices such as an on-vehicle motor, an on-vehicle generator, and an on-vehicle inductor.

Having described an embodiment in the above, it is understood that various changes in the embodiment and details are possible without departing from the sprit and scope of the claims.

<1> From a first aspect of the present disclosure, provided is:
an insulated electric wire comprising a conductor and a fluororesin layer containing a melt-fabricable fluororesin that is formed on the conductor, wherein a peel strength measured by peeling the fluororesin layer from the conductor is 0.30 N/mm or more.

<2> From a second aspect of the present disclosure, provided is:
the insulated electric wire according to the first aspect, wherein a cross-sectional shape of the conductor is an approximately rectangular shape.

<3> From a third aspect of the present disclosure, provided is:
an insulated electric wire comprising a conductor and a fluororesin layer containing a melt-fabricable fluororesin that is formed on the conductor, wherein a pullout strength measured by pulling the fluororesin out from the conductor is 4 N or more.

<4> From a fourth aspect of the present disclosure, provided is:
the insulated electric wire according to the third aspect, wherein a cross-sectional shape of the conductor is an appropriately circular shape.

<5> From a fifth aspect of the present disclosure, provided is:
the insulated electric wire according to any one of the first to fourth aspects, wherein the fluororesin layer is formed by extruding the fluororesin in a melted state onto the conductor heated to a temperature higher than the temperature of the fluororesin in a melted state.

<6> From a sixth aspect of the present disclosure, provided is:
the insulated electric wire according to any one of the first to fifth aspects, wherein the conductor is composed of at least one selected from the group consisting of copper, copper alloy, aluminum and aluminum alloy.

<7> From a seventh aspect of the present disclosure, provided is:
the insulated electric wire according to any one of the first to sixth aspects, wherein the conductor has a surface roughness Sz of 0.2 to 12 μm.

<8> From an eighth aspect of the present disclosure, provided is:
the insulated electric wire according to any one of the first to seventh aspects, wherein the fluororesin layer has a thickness of 40 to 300 μm.

<9> From a ninth aspect of the present disclosure, provided is:
the insulated electric wire according to any one of the first to eighth aspects, wherein the fluororesin layer has a relative dielectric constant of 2.5 or less.

<10> From a tenth aspect of the present disclosure, provided is:
the insulated electric wire according to any one of the first to ninth aspects, wherein a partial discharge inception voltage measured at 25° C. satisfies the following relational expression:

$$Partial discharge inception voltage ( V ) \geq 5.5 \times t + 600$$

t: film thickness of fluororesin layer (μm)

<11> From an eleventh aspect of the present disclosure, provided is:
the insulated electric wire according to any one of the first to tenth aspects, wherein a rate of change calculated from the following formula is less than 10%:

$$Rate of change ( \% ) = [ ( Partial discharge inception voltage measured at 25 ° C . ) - \text{} ( Partial discharge inception voltage measured at 200 ° C . ) ] \text{} / \text{} ( Partial discharge inception voltage measured at 25 ° C . ) \times 100$$

<12> From a twelfth aspect of the present disclosure, provided is:
the insulated electric wire according to any one of the first to eleventh aspects, wherein the fluororesin has a melt flow rate of 0.1 to 120 g/10 minutes.

<13> From a thirteenth aspect of the present disclosure, provided is:
the insulated electric wire according to any one of the first to twelfth aspects, wherein the fluororesin has a melting point of 240 to 320° C.

<14> From a fourteenth aspect of the present disclosure, provided is:
the insulated electric wire according to any one of the first to thirteenth aspects, wherein the fluororesin has a functional group, and the number of functional groups of the fluororesin is 5 to 2,000 per 10⁶ carbon atoms.

<15> From a fifteenth aspect of the present disclosure, provided is:
the insulated electric wire according to any one of the first to fourteenth aspects, wherein the fluororesin contains tetrafluoroethylene unit and a fluoroalkyl vinyl ether unit.

<16> From a sixteenth aspect of the present disclosure, provided is:
the insulated electric wire according to the fifteenth aspect, wherein the fluororesin has a fluoroalkyl vinyl ether unit content of 1.0 to 30.0 mol % relative to all the monomer units.

<17> From a seventeenth aspect of the present disclosure, provided is:
the insulated electric wire according to any one of the first to fourteenth aspects, wherein the fluororesin contains tetrafluoroethylene unit and hexafluoropropylene unit.

<18> From an eighteenth aspect of the present disclosure, provided is:
the insulated electric wire according to any one of the first to seventeenth aspects, wherein the fluororesin contains at least one functional group selected from the group consisting of a carbonyl group-containing group, an amino group, a hydroxy group, —CF₂H group, an olefin group, an epoxy group and an isocyanate group.

<19> From a nineteenth aspect of the present disclosure, provided is:
a method for producing an insulated electric wire, which is for producing the insulated electric wire according to any one of the first to eighteenth aspects using an extruder, comprising:
heating the fluororesin to melt the fluororesin, and extruding the fluororesin in a melted state onto the conductor heated to a temperature higher than the temperature of the fluororesin in a melted state, thereby forming the fluororesin layer on the conductor.

<20> From a twentieth aspect of the present disclosure, provided is:
the production method according to the nineteenth aspect, wherein the conductor is heated with a halogen heater.

### EXAMPLES

Next, an embodiment of the present disclosure is described with reference to Examples, though the present disclosure is not limited to the Examples only.

The respective numerical values in Examples were measured by the following methods.

### (Melt Flow Rate (MFR))

According to ASTM D1238, using a melt indexer (manufactured by Yasuda Seiki Seisakusho, Ltd.), a mass of the copolymer flowing out from a nozzle having an inner diameter of 2.1 mm and a length of 8 mm at 372° C. under a load of 5 kg per 10 minutes (g/10 minutes) was determined.

### (Melting Point)

The melting point was determined as a temperature responding to the maximum value of the quantity of heat of melting in the heat-of-fusion curve when temperature is raised at a rate of 10° C./minute using a differential scanning calorimeter (DSC).

### (Composition of Fluororesin)

The measurement was performed by ¹⁹F-NMR method.

### (Number of Functional Group)

A fluororesin was melted at 330 to 340° C. for 30 minutes and compression molded to make a film having a thickness of 0.20 to 0.25 mm. The film was scanned 40 times by a Fourie-transform infrared spectroscopy (FT-IR (trade name: 1760× type, manufactured by PerkinElmer, Inc.) to obtain an infrared absorption spectrum through analysis. A differential spectrum, which is a difference from a base spectrum of a completely fluorinated resin having no functional group, was obtained. From the absorption peak of a specific functional group appearing in the differential spectrum, the number N of the functional groups per 10⁶ carbon atoms in the fluororesin was calculated according to the following formula (A).

$$N = I \times K / t \qquad ( A )$$

I: absorbance
K: correction coefficient
T: film thickness (mm)

For reference sake, the absorption frequency, molar absorption coefficient and correction coefficient of the functional groups of the present disclosure are shown in Table 2. Incidentally, the molar absorption coefficient was determined from the FT-IR measurement data of a low molecular weight model compound.

TABLE 2

| | | Molar | | |
|---|---|---|---|---|
| | Absorption | Extinction | | |
| | Frequency | Coefficient | Correction | |
| Functional Group | (cm⁻¹) | (l/cm/mol) | Factor | Model Compound |
| —COF | 1883 | 600 | 388 | C₇F₁₅COF |
| —COOH free | 1815 | 530 | 439 | H(CF₂)₆COOH |
| —COOH bonded | 1779 | 530 | 439 | H(CF₂)₆COOH |
| —COOCH₃ | 1795 | 680 | 342 | C₇F₁₅COOCH₃ |
| —CONH₂ | 3436 | 506 | 460 | C₇H₁₅CONH₂ |
| —CH₂OH₂, —OH | 3648 | 104 | 2236 | C₇H₁₅CH₂OH |
| —CF₂H | 3020 | 8.8 | 26485 | H(CF₂CF₂)₃CH₂OH |
| —CF═CF₂ | 1795 | 635 | 366 | CF₂=CF₂ |

### (Thickness of Fluororesin Layer)

A micrometer was used for the measurement.

(Temperature of Conductor when Conductor and Resin Come into Contact)

A non-contact radiation thermometer (manufactured by Japansensor Corporation) was fixed such that a spot apart from a downstream end in the moving direction of the traveling line in the heating region of the conductor by 10 cm in the moving direction of the traveling line was focused for measurement of the temperature of the conductor out of the heating region of the conductor. In the case where the cross-sectional shape of the conductor is an approximately rectangular shape, regarding the face to be measured, each of the long face part (main face) and the short face part (side face) of the conductor was measured as measurement surface, and as calibration, the temperature (room temperature) of each of the surfaces of the conductor before heating measured by a contact thermometer (manufactured by Anritsu Meter Co., Ltd.) was set. The measurement angle was vertical to the surface. A light shielding plate was installed between the heat source and the temperature measurement part, such that the measurement is not affected by the heat source and the light reflection in the room.

Alternatively, a scanning-type contact thermometer may be fixed at a spot 10 cm apart in the moving direction of the traveling line from a downstream end in the moving direction of the traveling line in the heating region of the conductor for measurement of the temperature of the surface of the conductor. In the case where the cross-sectional shape of the conductor is an approximately rectangular shape, regarding the face to be measured, each of the long face part (main face) and the short face part (side face) of the conductor is measured, and setting is performed such that the conductor comes into contact with the sensor at right angle. In the case where the conductor has a round cross section, setting is performed such that the traveling conductor comes into contact with the sensor at right angle.

In the case where the cross-sectional shape of the conductor is an approximately rectangular shape, it is checked that the difference in temperature between the long face part (main face) and the short face part (side face) is within ±20° C.

### (Method for Heating Conductor)

As the heating source, a line light heating of a halogen heater (lamp heater) (manufactured by Inflidge Industrial, Ltd.) was installed to have a length of 35 cm from the entrance of the extruder to the central lamp of the halogen heater. The heater was fixed such that the lamp came into contact with the surface of the conductor at right angle.

(Resin Temperature when Conductor Comes into Contact with Resin)

Before initiation of forming of the electric wire coating, the fluororesin in a melted state was extruded through a die of the extruder, and the temperature of the extruded fluororesin at the die head outlet was measured by a thermocouple.

### (Surface Roughness Sz)

The surface roughness Sz in a field of view of 8000 μm² was measured with a laser microscope (manufactured by Keyence Corporation).

### (Relative Dielectric Constant)

The strand prepared by the melt indexer was cut out into a strip with a width of 2 mm and a length of 100 mm, of which changes in resonant frequency and electric field intensity at 2.45 GHz were measured at a temperature of 20 to 25° C., using a network analyzer HP8510C (manufactured by Hewlett-Packard Company) and a cavity resonator.

### (Pullout Strength)

Measurement was performed using AGS-X autograph (5 kN) (manufactured by Shimadzu Corporation). An electric wire was cut into a length of 70 mm, and the coating in a length of 20 mm from an end was peeled off in advance. To an upper chuck, a jig having a hole larger than the diameter of the conductor and thinner than the diameter of the electric wire was then attached. Then, the part of the stripped conductor only was put through the jig, and the stripped conductor was fixed to the lower chuck. The device was moved in the pulling direction to pull out the coated portion only. The maximum point stress when pulling was performed to a travel distance of 30 mm at 50 mm/min was defined as the pullout strength.

### (Peel Strength)

AGS-J Autograph (50 N) (manufactured by Shimadzu Corporation) was used for the measurement. Two approximately parallel notches with a length of 50 mm in the long axis direction were made, and at both ends thereof, the coating was notched at right angle in the short axis direction. The ends were peeled to a length of 10 mm and clamped in the upper chuck. The conductor was fixed to the lower part to horizontalize the long face direction. When the device was moved in the pulling direction, using a jig moving in the lateral direction responding to the moving distance in the vertical direction in an interlocking manner, the angle was adjusted such that the peeled coating was always vertical to the conductor in the long face direction. The tensile stress was measured for pulling at 100 mm/min to a peel length of 30 mm, and the maximum point stress was defined as peel strength.

In other words, using AGS-J Autograph (50 N) (manufactured by Shimadzu Corporation), the peel strength of the coating on a main face of the conductor (flat wire) of an insulated electric wire was measured. Of the two pairs of opposing faces of the flat wire, the face having a larger size in the width direction of the conductor (face of long side vertical to the longitudinal direction of the conductor) was defined as main face, and a face conductor orthogonal to the main face (face of short side vertical to the longitudinal direction) was defined as side face. The size of the width direction of the conductor of the main face is larger than the size of the width direction of the conductor of the side face. Two notches in approximately parallel were made on the coating on one main face along the longitudinal direction of the insulated electric wire, and further two notches orthogonal to the longitudinal direction were made with a space of 50 mm. The end of notched coating was peeled from the conductor to make a holding part of 10 mm. The insulated electric wire was fixed to the jig such that the other main face was in a downward direction. The holding part was held in the upper chuck, and folded back at 90 degrees. A moving jig was used such that the angle between the insulated electric wire fixed to the jig and the coating was held at 90 degrees. The coating was peeled at a pulling rate of 100 mm/min to a length of 30 mm to measure the tensile stress. The maximum point stress was defined as peel strength.

### (Bending Test)

When both sides at spots 10 mm away from the base point of a U-shaped coil were bent to R2 in the long axis direction (longitudinal direction), one that had at least one of floating, wrinkles, cracks in the fluororesin layer was evaluated as poor, and one that had none of floating, wrinkles, cracks was evaluated as good.

### (Appearance of Insulated Electric Wire)

One that had at least one of melt fracture and discoloration in the insulating coating was evaluated as poor, and one that had no melt fracture and no discoloration was evaluated as good.

### (Partial Discharge Initiation Voltage (PDIV) (25° C., 200° C.))

Two insulated electric wires having a cut length of 90 cm were twisted together under a tension of 13.5 N, so that a stranded coil having a portion stranded 8 times in a central region with a length of 125 mm was prepared. The insulating coating at a sample end with a length of 10 mm was then removed. The measurement was performed by applying 50-Hz sine wave alternating voltage between the conductors of the two insulated electric wires, at an environmental temperature of 25° C. (relative humidity: 50%) or 200° C. (relative humidity: 50%), using a partial discharge measuring device (DAC-PD-7, manufactured by Soken Electric Co., Ltd.) With a voltage raising rate set to 50 V/sec, a voltage lowering rate set to 50 V/sec and a voltage retention time set to 0 sec, the voltage at an occurrence time of discharge of 10 pC or more was defined as partial discharge inception voltage.

In Examples and Comparative Examples, the following conductors were used.
Conductor 1: flat wire of copper having an approximately rectangular cross section, thickness (short side): 2.0 mm, width (long side): 3.4 mm
Conductor 2: round wire having an appropriately circular cross section, diameter: 1.0 mm

### Comparative Example 1 and Comparative Example 1′

As the resin for forming the insulating coating in Comparative Example 1 and Comparative Example 1′, a copolymer of tetrafluoroethylene and perfluoro(propyl vinyl ether) (PFA) having an MFR of 14 g/10 min and a melting point of 306° C. was used. The resin temperature at the die outlet in forming of the electric wire was controlled to 365° C., so that a 200-μm extruded coating layer was formed. When the conductor came into contact with the resin, the temperature of the conductor was controlled to 260° C.

As the index of adhesion, the pullout strength of the round wire in Comparative Example 1 was 2.0 N, and the peel strength of the flat wire in Comparative Example 1′ was 0.001 N/mm. Further, during bending of the flat wire, floating and wrinkles of the coating were observed, so that it has been confirmed that the adhesion of the resin to the conductor was like wrapping, not in close contact.

### Comparative Example 2

As the resin for forming the insulating coating in Comparative Example 2, a copolymer of tetrafluoroethylene and perfluoro(propyl vinyl ether) (PFA) having an MFR of 68 g/10 min and a melting point of 295° C. was used. The resin temperature at the die outlet in forming of the electric wire was controlled to 360° C., so that a 200-μm extruded coating layer was formed. When the conductor came into contact with the resin, the temperature of the conductor was controlled to 300° C.

As the index of adhesion, the peel strength of the flat wire in Comparative Example 2 was 0.25 N/mm, and during bending of the flat wire, floating and wrinkles of the coating were observed, so that it has been confirmed that the adhesion of the resin to the conductor was like wrapping, not in close contact.

### Example 1 and Example 1′

As the resin for forming the insulating coating in Example 1 and Example 1′, the same one as in Comparative Example 2 was used. The resin temperature at the die outlet in forming of the electric wire was controlled to 330° C., so that a 200-μm extruded coating layer was formed. When the conductor came into contact with the resin, the temperature of the conductor was controlled to 350° C.

As the index of adhesion, the pullout strength of the round wire in Example 1 was 14.0 N, and the peel strength of the flat wire in Example 1′ was 1.80 N/mm. During bending of the flat wire, floating as well as wrinkles of the coating was not observed, so that it has been confirmed that the adhesion of the resin to the conductor was higher than each in Comparative Example 1 and Comparative Example 1′ regardless of the shape of the conductor.

### Example 2 and Example 2′

As the resin for forming the insulating coating in Example 2 and Example 2′, the same ones as in Comparative Example 1 and Comparative Example 1′ were used. The resin temperature at the die outlet in forming of the electric wire was controlled to 420° C., so that a 200-μm extruded coating layer was formed. When the conductor came into contact with the resin, the temperature of the conductor was controlled to 450° C.

As the index of adhesion, the pullout strength of the round wire in Example 1 was 20.0 N, and the peel strength of the flat wire in Example 1′ was 2.80 N/mm. During bending of the flat wire, floating as well as wrinkles of the coating was not observed, so that it has been confirmed that the adhesion of the resin to the conductor was higher than each in Example 1 and Example 1′ regardless of the shape of the conductor.

### Example 3 and Example 3′

As the resin for forming the insulating coating in Example 3 and Example 3′, a copolymer of tetrafluoroethylene and perfluoro(propyl vinyl ether) (PFA) having an MFR of 28 g/10 min and a melting point of 303° C. was used. The resin temperature at the die outlet in forming of the electric wire was controlled to 330° C., so that a 140-μm extruded coating layer was formed. When the conductor came into contact with the resin, the temperature of the conductor was controlled to 350° C.

As the index of adhesion, the pullout strength of the round wire in Example 3 was 15.0 N, and the peel strength of the flat wire in Example 3′ was 1.80 N/mm. During bending of the flat wire, floating as well as wrinkles of the coating was not observed.

### Example 4 and Example 4′

As the resin for forming the insulating coating in Example 4 and Example 4′, the same ones as in Comparative Example 1 and Comparative Example 1′ were used. The resin temperature at the die outlet in forming of the electric wire was controlled to 350° C., so that a 200-μm extruded coating layer was formed. When the conductor came into contact with the resin, the temperature of the conductor was controlled to 400° C. Further, regarding the insulated electric wire in Example 4′, the electric wire after forming was baked at 330° C. for 2 minutes, and at 350° C. for 1 minute.

As the index of adhesion, the peel strength of the flat wire in Example 4 and Example 4′ were 2.21 N/mm and 2.20 N/mm, respectively. In other words, each had the adhesion strength at the same level.

### Example 5

As the resin for forming the insulating coating in Example 5, the same ones as in Example 3′ was used. The resin temperature at the die outlet in forming of the electric wire was controlled to 310° C., so that a 200-μm extruded coating layer was formed. When the conductor came into contact with the resin, the temperature of the conductor was controlled to 320° C.

As the index of adhesion, the peel strength of the flat wire in Example 5 was 0.93 N/mm. During bending of the flat wire, floating as well as wrinkles of the coating was not observed.

### Example 6

As the resin for forming the insulating coating in Example 6, the same ones as in Comparative Example 2 was used. The resin temperature at the die outlet in forming of the electric wire was controlled to 300° C., so that a 200-μm extruded coating layer was formed. When the conductor came into contact with the resin, the temperature of the conductor was controlled to 320° C.

As the index of adhesion, the peel strength of the flat wire in Example 6 was 1.00 N/mm. During bending of the flat wire, floating as well as wrinkles of the coating was not observed.

### Example 7 and Example 7′

As the resin for forming the insulating coating in Example 7, a copolymer of tetrafluoroethylene and perfluoro(propyl vinyl ether) (PFA) having an MFR of 2 g/10 min and a melting point of 307° C. was used. The resin temperature at the die outlet in forming of the electric wire was controlled to 424° C., so that a 200-μm extruded coating layer was formed. When the conductor came into contact with the resin, the temperature of the conductor was controlled to 455° C.

As the index of adhesion, the pullout strength of the round wire in Example 7 was 16.0 N, and the peel strength of the flat wire in Example 7′ was 1.70 N/mm. During bending of the flat wire, although floating as well as wrinkles of the coating was not observed, generation of melt fractures in the surface of the electric wire caused appearance defects.

### Example 8

As the resin for forming the insulating coating in Example 8, a copolymer of tetrafluoroethylene and perfluoro(propyl vinyl ether) (PFA) having an MFR of 68 g/10 min and a melting point of 295° C. was used. For the conductor for use in Example 8, one having a surface roughness Sz of 7.72 μm was used. The resin temperature at the die outlet in forming of the electric wire was controlled to 360° C., so that a 200-μm extruded coating layer was formed. When the conductor came into contact with the resin, the temperature of the conductor was controlled to 400° C.

As the index of adhesion, the peel strength of the flat wire in Example 8 was 3.50 N/mm. During bending of the flat wire, floating as well as wrinkles of the coating was not observed.

### Comparative Example 3 and Comparative Example 3′

As the resin for forming the insulating coating in Comparative Example 3 and Comparative Example 3′, the same ones as in Comparative Example 1 and Comparative Example 1′ were used. The resin temperature at the die outlet in forming of the electric wire was controlled to 365° C., so that a 200-μm extruded coating layer was formed. The temperature of the conductor at the head outlet was controlled to 260° C. Further, regarding the insulated electric wire in Comparative Example 3 and Comparative Example 3′, the electric wire after forming was baked at 330° C. for 2 minutes, and at 350° C. for 1 minute.

As the index of adhesion, the pullout strength of the round wire in Comparative Example 3 was 3.0 N, and the peel strength of the flat wire in Comparative Example 3′ was 0.001 N/mm. In other words, the adhesion strength was at the same level as in Comparative Example 1.

### Comparative Example 4

As the resin for forming the insulating coating in Comparative Example 4, the same one as in Comparative Example 1 was used. As the conductor for use in Comparative Example 4, only a conductor was heated at 380° C. and wound up. After winding up the conductor, as in Comparative Example 1, the resin temperature at the die outlet in forming of the electric wire was controlled to 365° C., and when the conductor came into contact with the resin, the temperature of the conductor was controlled to 260° C., so that a 200-μm extruded coating layer was formed.

As the index of adhesion, the pullout strength of the round wire in Comparative Example 4 was 3.0 N, so that the adhesion strength was at the same level as in Comparative Example 1.

### Example 9 and Example 9′

As the resin for forming the insulating coating in Example 9 and Example 9′, the same one as in Comparative Example 1 was used. The resin temperature at the die outlet in forming of the electric wire was controlled to 365° C., so that 100-μm and 60-μm extruded coating layers were formed, respectively. When the conductor came into contact with the resin, the temperature of the conductor was controlled to 380° C.

As the index of adhesion, the pullout strength of the round wire in Example 9 was 11.0 N, and the peel strength of the flat wire in Example 9′ was 0.62 N/mm. In other words, the adhesion strength was more than those in Comparative Example 3′ and Comparative Example 4.

### Example 10

As the resin for forming the insulating coating in Example 10, a ternary copolymer of tetrafluoroethylene, hexafluoropropylene and perfluoro(propyl vinyl ether) having an MFR of 6 g/10 min and a melting point of 265° C. was used. The resin temperature at the die outlet in forming of the electric wire was controlled to 300° C., so that a 200-μm extruded coating layer was formed. When the conductor came into contact with the resin, the temperature of the conductor was controlled to 323° C.

As the index of adhesion, although the peel strength of the flat wire in Example 10 was 1.20 N/mm, generation of melt fractures in the surface of the electric wire caused appearance defects.

### Example 11

As the resin for forming the insulating coating in Example 11, a copolymer of tetrafluoroethylene and hexafluoropropylene having an MFR of 6 g/10 min and a melting point of 270° C. was used. The resin temperature at the die outlet in forming of the electric wire was controlled to 325° C., so that a 200-μm extruded coating layer was formed. When the conductor came into contact with the resin, the temperature of the conductor was controlled to 350° C.

As the index of adhesion, the pullout strength of the round wire in Example 11 was 15.0 N.

The conditions for forming the electric wire and results are shown in Table 3 and Table 4.

TABLE 3

| | | Comparative | Comparative | Comparative | | | | | | | | | | |
|---|---|---|---|---|---|---|---|---|---|---|---|---|---|---|
| | | Example 1 | Example 1′ | Example 2 | Example 1 | Example 1′ | Example 2 | Example 2′ | Example 3 | Example 3′ | Example 4 | Example 4′ | Example 5 | Example 6 |
| MFR of fluororesin [g/10 min] | | 14 | 14 | 68 | 68 | 68 | 14 | 14 | 28 | 28 | 14 | 14 | 28 | 68 |
| Melting point of fluororesin [° C.] | | 306 | 306 | 295 | 295 | 295 | 306 | 306 | 303 | 303 | 306 | 306 | 301 | 295 |
| Composition of | TFE[mol %] | 98.2 | 98.2 | 97.4 | 97.4 | 97.4 | 98.2 | 98.2 | 97.6 | 97.6 | 98.2 | 98.2 | 97.6 | 97.4 |
| fluororesin | PPVE[mol %] | 1.8 | 1.8 | 2.6 | 2.6 | 2.6 | 1.8 | 1.8 | 2.4 | 2.4 | 1.8 | 1.8 | 2.4 | 2.6 |
| | HFP[mol %] | — | — | — | — | — | — | — | — | — | — | — | — | — |
| | Functional group | 55 | 55 | 808 | 808 | 808 | 55 | 55 | 169 | 169 | 55 | 55 | 169 | 808 |
| | [pieces/10⁶ | | | | | | | | | | | | | |
| | carbon | | | | | | | | | | | | | |
| | atoms] | | | | | | | | | | | | | |
| Thickness of fluororesin layer/μm | | 200 | 200 | 200 | 200 | 200 | 200 | 200 | 140 | 140 | 200 | 200 | 200 | 200 |
| Temperature of conductor when | | 260 | 260 | 300 | 350 | 350 | 450 | 450 | 350 | 350 | 400 | 400 | 320 | 320 |
| conductor comes into contact with | | | | | | | | | | | | | | |
| resin/° C. | | | | | | | | | | | | | | |
| Temperature of resin when conductor | | 365 | 365 | 360 | 330 | 330 | 420 | 420 | 330 | 330 | 350 | 350 | 310 | 300 |
| comes into contact with resin/° C. | | | | | | | | | | | | | | |
| Cross-sectional | Approximately | — | good | good | — | good | — | good | — | good | good | good | good | good |
| shape | rectangular | | | | | | | | | | | | | |
| of conductor | shape | | | | | | | | | | | | | |
| | (2 mm × 3.4 mm) | | | | | | | | | | | | | |
| | Approximately | good | — | — | good | — | good | — | good | — | — | — | — | — |
| | circular shape | | | | | | | | | | | | | |
| | (1 mmφ) | | | | | | | | | | | | | |
| Surface roughness of conductor Sz/μm | | 0.45 | 0.95 | 0.95 | 0.45 | 0.95 | 0.45 | 0.95 | 0.45 | 0.95 | 0.95 | 0.95 | 0.95 | 0.95 |
| Dielectric constant of fluororesin | | 2.1 | 2.1 | 2.1 | 2.1 | 2.1 | 2.1 | 2.1 | 2.1 | 2.1 | 2.1 | 2.1 | 2.1 | 2.1 |
| Annealing temperature/° C. | | — | — | — | — | — | — | — | — | — | — | 330/350 | — | — |
| Pullout strength/N | | 2.0 | — | — | 14.0 | — | 20.0 | — | 15.0 | — | — | — | — | — |
| Peel strength/N/mm | | — | 0.001 | 0.25 | — | 1.80 | — | 2.80 | — | 1.80 | 2.21 | 2.20 | 0.93 | 1.00 |
| Bending test | | — | poor | poor | — | good | — | good | — | good | good | good | good | good |
| PDIV | 25° C. | 1824 | — | — | 1886 | — | 1883 | — | 1549 | — | — | — | — | — |
| | 200° C. | 1593 | — | — | 1862 | — | 1868 | — | 1532 | — | — | — | — | — |

| | | | | | | | | | | | | | |
|---|---|---|---|---|---|---|---|---|---|---|---|---|---|
| Appearance of insulated electric wire | good | good | good | good | good | good | good | good | good | good | good | good | good |

TABLE 4

| | | | | | Comparative | Comparative | Comparative | |
|---|---|---|---|---|---|---|---|---|
| | | Example 7 | Example 7′ | Example 8 | Example 3 | Example 3′ | Example 4 | Example 9 |
| MFR of fluororesin [g/10 min] | | 2 | 2 | 68 | 14 | 14 | 14 | 14 |
| Melting point of fluororesin [° C.] | | 307 | 307 | 295 | 306 | 306 | 306 | 306 |
| Composition of | TFE[mol %] | 98.5 | 98.5 | 97.4 | 98.2 | 98.2 | 98.2 | 98.2 |
| fluororesin | PPVE[mol %] | 1.5 | 1.5 | 2.6 | 1.8 | 1.8 | 1.8 | 1.8 |
| | HFP[mol %] | — | — | — | — | — | — | — |
| | Functional group | 12 | 12 | 808 | 55 | 55 | 55 | 55 |
| | [pieces/10⁶ | | | | | | | |
| | carbon | | | | | | | |
| | atoms] | | | | | | | |
| Thickness of fluorores in layer/μm | | 200 | 200 | 200 | 200 | 200 | 200 | 100 |
| Temperature of conductor when | | 455 | 455 | 400 | 260 | 260 | 260 | 380 |
| conductor comes into contact with | | | | | | | | |
| resin/° C. | | | | | | | | |
| Temperature of resin when conductor | | 424 | 424 | 360 | 365 | 365 | 365 | 365 |
| comes into contact with resin/° C. | | | | | | | | |
| Cross-sectional | Approximately | — | good | good | — | good | — | — |
| shape | rectangular | | | | | | | |
| of conductor | shape | | | | | | | |
| | (2 mm × 3.4 mm) | | | | | | | |
| | Approximately | good | — | — | good | — | good | good |
| | circular shape | | | | | | | |
| | (1 mmφ) | | | | | | | |
| Surface roughness of conductor Sz/μm | | 0.45 | 0.95 | 7.72 | 0.45 | 0.95 | 0.45 | 0.45 |
| Dielectric constant of fluororesin | | 2.1 | 2.1 | 2.1 | 2.1 | 2.1 | 2.1 | 2.1 |
| Annealing temperature/° C. | | — | — | — | 330/350 | 330/350 | — | — |
| Pullout strength/N | | 16.0 | — | — | 3.0 | — | 3.0 | 11.0 |
| Peel strength/N/mm | | — | 1.70 | 3.50 | — | 0.001 | — | — |
| Bending test | | — | good | good | — | poor | — | — |
| PDIV | 25° C. | 1870 | — | — | 1850 | — | 1863 | 1326 |
| | 200° C. | 1820 | — | — | 1629 | — | 1602 | 1312 |

| | | | | | | | |
|---|---|---|---|---|---|---|---|
| Appearance of insulated electric wire | poor | poor | good | good | good | good | good |

| | | Example 9′ | Example 10 | Example 11 |
|---|---|---|---|---|
| MFR of fluororesin [g/10 min] | | 14 | 6 | 6 |
| Melting point of fluororesin [° C.] | | 306 | 265 | 270 |
| Composition of | TFE[mol %] | 98.2 | 91.9 | 92.4 |
| fluororesin | PPVE[mol %] | 1.8 | 0.4 | — |
| | HFP[mol %] | — | 7.7 | 7.6 |
| | Functional group | 55 | 1150 | 625 |
| | [pieces/10⁶ | | | |
| | carbon | | | |
| | atoms] | | | |
| Thickness of fluorores in layer/μm | | 60 | 200 | 200 |
| Temperature of conductor when | | 380 | 323 | 350 |
| conductor comes into contact with | | | | |
| resin/° C. | | | | |
| Temperature of resin when conductor | | 365 | 300 | 325 |
| comes into contact with resin/° C. | | | | |
| Cross-sectional | Approximately | good | good | — |
| shape | rectangular | | | |
| of conductor | shape | | | |
| | (2 mm × 3.4 mm) | | | |
| | Approximately | — | — | good |
| | circular shape | | | |
| | (1 mmφ) | | | |
| Surface roughness of conductor Sz/μm | | 0.95 | 0.95 | 0.45 |
| Dielectric constant of fluororesin | | 2.1 | 2.1 | 2.1 |
| Annealing temperature/° C. | | — | — | — |
| Pullout strength/N | | — | — | 15.0 |
| Peel strength/N/mm | | 0.62 | 1.20 | — |
| Bending test | | good | good | — |
| PDIV | 25° C. | — | — | 1048 |
| | 200° C. | — | — | 1030 |

| | | | |
|---|---|---|---|
| Appearance of insulated electric wire | good | poor | good |

1. An insulated electric wire comprising a conductor and a fluororesin layer containing a melt-fabricable fluororesin that is formed on the conductor, wherein
(a) a peel strength measured by peeling the fluororesin layer from the conductor is 0.30 N/mm or more, or
(b) a pullout strength measured by pulling the fluororesin out from the conductor is 4 N or more.

2. The insulated electric wire according to claim 1, wherein a cross-sectional shape of the conductor is an approximately rectangular shape in case that the insulated electric wire has the peel strength.

3. The insulated electric wire according to claim 1, wherein a cross-sectional shape of the conductor is an appropriately circular shape in case that the insulated electric wire has the pullout strength.

4. The insulated electric wire according to claim 1, wherein the fluororesin layer is formed by extruding the fluororesin in a melted state onto the conductor heated to a temperature higher than the temperature of the fluororesin in a melted state.

5. The insulated electric wire according to claim 1, wherein the conductor is composed of at least one selected from the group consisting of copper, copper alloy, aluminum and aluminum alloy.

6. The insulated electric wire according to claim 1, wherein the conductor has a surface roughness Sz of 0.2 to 12 μm.

7. The insulated electric wire according to claim 1, wherein the fluororesin layer has a thickness of 40 to 300 μm.

8. The insulated electric wire according to claim 1, wherein the fluororesin layer has a relative dielectric constant of 2.5 or less.

9. The insulated electric wire according to claim 1, wherein a partial discharge inception voltage measured at 25° C. satisfies the following relational expression:
$$Partial discharge inception voltage ( V ) \geq 5.5 \times t + 600$$
t: film thickness of fluororesin layer (μm).

10. The insulated electric wire according to claim 1, wherein a rate of change calculated from the following formula is less than 10%:
$$Rate of change ( \% ) = [ ( Partial discharge inception voltage measured at 25 ° C . ) - \text{} ( Partial discharge inception voltage measured at 200 ° C . ) ] / \text{} ( Partial \text{} discharge inception voltage measured at 25 ° C . ) \times 100.$$

11. The insulated electric wire according to claim 1, wherein the fluororesin has a melt flow rate of 0.1 to 120 g/10 minutes.

12. The insulated electric wire according to claim 1, wherein the fluororesin has a melting point of 240 to 320° C.

13. The insulated electric wire according to claim 1, wherein the fluororesin has a functional group, and the number of functional groups of the fluororesin is 5 to 2,000 per 10⁶ carbon atoms.

14. The insulated electric wire according to claim 1, wherein the fluororesin contains tetrafluoroethylene unit and a fluoroalkyl vinyl ether unit.

15. The insulated electric wire according to claim 14, wherein the fluororesin has a fluoroalkyl vinyl ether unit content of 1.0 to 30.0 mol % relative to all the monomer units.

16. The insulated electric wire according to claim 1, wherein the fluororesin contains tetrafluoroethylene unit and hexafluoropropylene unit.

17. The insulated electric wire according to claim 1, wherein the fluororesin contains at least one functional group selected from the group consisting of a carbonyl group-containing group, an amino group, a hydroxy group, —CF₂H group, an olefin group, an epoxy group and an isocyanate group.

18. A method for producing an insulated electric wire, which is for producing the insulated electric wire according to claim 1 using an extruder, comprising:
heating the fluororesin to melt the fluororesin, and extruding the fluororesin in a melted state onto the conductor heated to a temperature higher than the temperature of the fluororesin in a melted state, thereby forming the fluororesin layer on the conductor.

19. The production method according to claim 18, wherein the conductor is heated with a halogen heater.
